(19) United States
(12) Patent Application Publication
(10) Pub. No.: US 2014/0158607 A1
(43) Pub. Date: Jun. 12, 2014

(54) FILTER WITH ABSORBING EXPANSION VOLUME

(71) Applicant: Mahle International GmbH, Stuttgart (DE)

(72) Inventors: Zhouxuan Xia, Windsor (CA); Kevin Mulkeran, Holly, MI (US); Wing Chan, Novi, MI (US); Mark Dean, Rochester Hills, MI (US)

(73) Assignee: Mahle International GmbH, Stuttgart (DE)

(21) Appl. No.: 14/099,533

(22) Filed: Dec. 6, 2013

Related U.S. Application Data
(60) Provisional application No. 61/735,753, filed on Dec. 11, 2012.

(51) Int. Cl. B01D 35/31

(52) U.S. Cl. CPC B01D 35/31
USPC 210/435

(57) ABSTRACT

A container may include a housing and a filter element configured to separate a contaminant from a liquid. A compliant element may surround a perimeter of the filter element within the housing. The compliant element may include, for example, a compliant tubing or foam. The compliant element may be configured to absorb the expansion of the liquid as it freezes to a solid to prevent damage to the housing and/or filter element.

### CROSS REFERENCE TO RELATED APPLICATIONS

This application claims the benefit of U.S. Provisional Application 61/735,753 filed on Dec. 11, 2012, the contents of which are incorporated herein in their entirety.

### BACKGROUND

Water may naturally accumulate in hydrocarbon liquids, such as diesel fuel, gasoline or urea, merely as examples, through a number of known mechanisms. For example, water vapor may condense in fuel stored in a closed tank or vessel for an extended period of time. Water may also accumulate in hydrocarbon liquids during transportation from refineries to service stations. The accumulation of water in a hydrocarbon liquid such as fuel is problematic for internal combustion engines, and especially diesel engines, as it may cause corrosion and/or growth of microorganisms that can damage engine components. As such, water filters are often employed to remove water from a hydrocarbon fuel supply for an engine.

Selective Catalytic Reduction systems have recently also become more common for diesel engine applications. Such systems may generally inject urea into an exhaust flow to reduce emissions of, for example, oxides of nitrogen, i.e., NO_{X}. Urea tanks are therefore commonly employed in diesel applications to provide a source of urea to be injected. Urea injection systems typically employ a urea filter to prevent contaminants from being injected along with the urea.

Storage of the above exemplary liquids in a closed container, e.g., a tank or filter, may generally be problematic as a result of expansion of the liquid upon freezing, e.g., water or urea, which in some solutions may also freeze during particularly cold engine operating conditions. Accordingly, water filters and urea tanks are subject to issues resulting from the elevated freezing temperature of water and urea compared with hydrocarbon fuels, especially where an associated engine must be stored or operated below the freezing temperature of water and/or urea. More specifically, a filter or storage tank associated with a freezing liquid is typically closed or sealed with respect to the environment. A quantity of liquid incorporating water may expand as it freezes into a solid, and the expansion resulting from this freezing process within a filter may damage the filter or components thereof. For example, the expansion in volume of water or urea as these liquids freeze into a solid may act on interior surface(s) of the filter or tank, thereby damaging the filter and/or components inside the filter or tank.

Some approaches to protecting filters or storage tanks from damage due to the volumetric expansion focus on absorbing forces caused by the solid as it expands outward within filter housing. However, this approach still results in stress to the housing that must be absorbed. Accordingly, there is a need for an improved storage or filtering system that resists damage due to freezing of a contained liquid.

### BRIEF DESCRIPTION OF THE DRAWINGS

FIG. 1 illustrates a partial sectional view of a container according to one example;

FIG. 2 illustrates a cross-sectional view of the container according to FIG. 1;

FIG. 3A illustrates a perspective view of a filter including a compliant element according to one example;

FIG. 3B illustrates a perspective view of a filter including a compliant element according to an example;

FIG. 3C illustrates a perspective cross-sectional view of a container including a compliant element according to another example;

FIG. 4A is a perspective front view of a cell cube including a quantity of liquid during a freezing process; and

FIG. 4B is a cross-sectional front view of the cell cube according to FIG. 4A including a compliant element therein.

### DETAILED DESCRIPTION

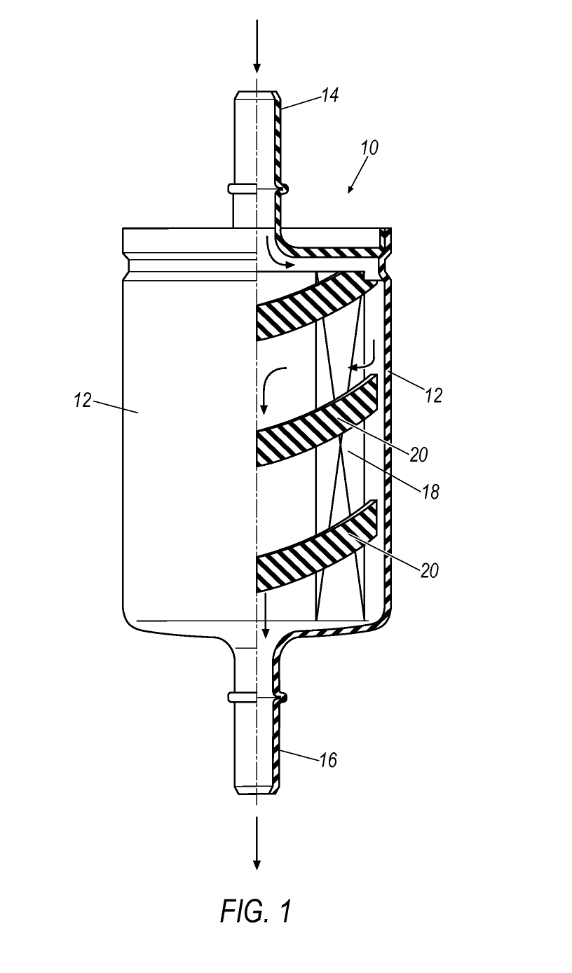

Various exemplary illustrations of a container with a compliant element that absorbs expansion of a liquid within container housing, e.g., water or urea, are provided herein. Referring to Figure. 1, an exemplary container 10 may include a housing 12, e.g., that defines a volume within the container 10, through which a liquid medium or fluid may be passed, for filtering and/or storage of the medium. The housing 12 may include an axial inlet 14 and outlet 16, which may be centrally located or may be offset towards a perimeter. The container 10 may, in some exemplary approaches, further include a filter element 18 received within the housing 12. The filter element 18 may include a solid top or cover over the top/face end to direct the liquid to the outer regions of the housing 12. The liquid may be introduced axially through the inlet 14 and flow radially to the outer portion of the housing 12. For instance, the liquid to be filtered may flow radially through the filter material from outside to inside. The filter element 18 may extend to the floor of the housing 12 to ensure the liquid flows through the filter element 18 before exiting the outlet 16. Thus, the filter element 18 may be configured to filter out contaminate from a liquid, e.g., water or other contaminants from a hydrocarbon fuel such as diesel, gasoline, or contaminants from urea, merely as examples, when the liquid flows through the container 10. After flowing radially through the filter element 18, the filtered liquid may be discharged axially through the outlet 16.

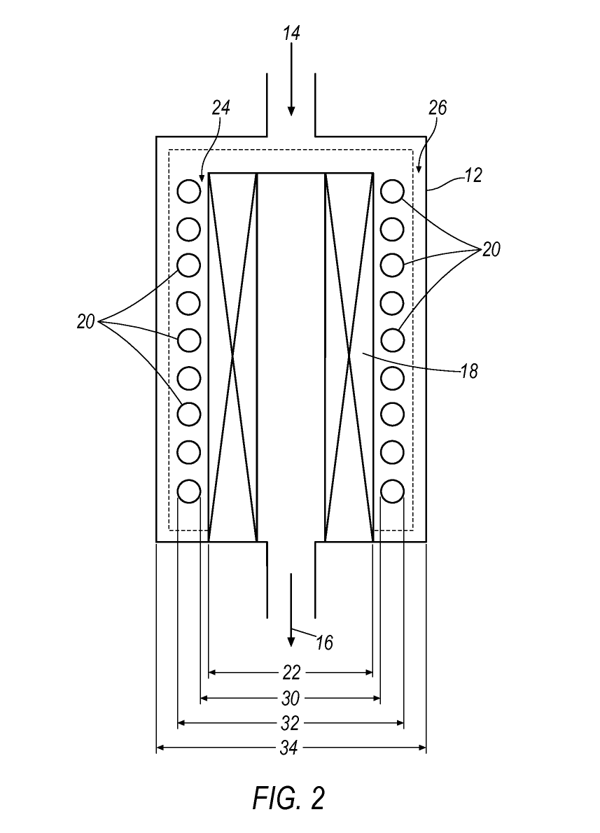

With reference to FIGS. 1 and 2, the container 10 may include a compliant element 20, for instance a compliant tubing or foam. An exemplary compliant element 20 may generally surround a perimeter of the filter element 18 within the housing 12. For instance, the compliant element 20 may be arranged surrounding a perimeter or outer diameter 22 of the filter element 18 (e.g., axially adjacent to the outer diameter 22 of the filter element 18). The compliant element 20 may generally absorb a change in volume of a quantity of liquid within the housing 12 as it freezes into a solid, particularly when water is a component. For example, an exemplary compliant element 20 may generally be positioned within an outer portion of a volume defined by the housing 12. The compliant element 20 may have an initial size or volume, and may be compressed into a smaller size or volume as the liquid freezes, thereby expanding within the housing 12. Accordingly, the compliant element 20 may have a resilient and/or elastically deformable design, which may allow for the compliant element 20 to deform/compress as stress or pressure arises in the housing 12 (e.g., in the case of liquid freezing into solid). Similarly, the resiliency allows for the compliant element 20 to expand back to its initial size or volume.

The compliant element 20 may be “compliant” relative to the housing 12. For example, the compliance of the compliant tubing or foam element 20 may be sufficiently greater than at least the housing 12 material, so that deflection of the compliant element 20 occurs in the compliant element 20 in favor of deflecting (and possibly damaging) the housing 12. The compliant tubing or foam element 20 may thereby generally reduce in size or volume, e.g., as a result of the compression by the freezing liquid, to absorb expansion of a filtered material, e.g., water or urea, to reduce the damage to filter components such as the housing 12 and/or filter element 18, as will be described further below.

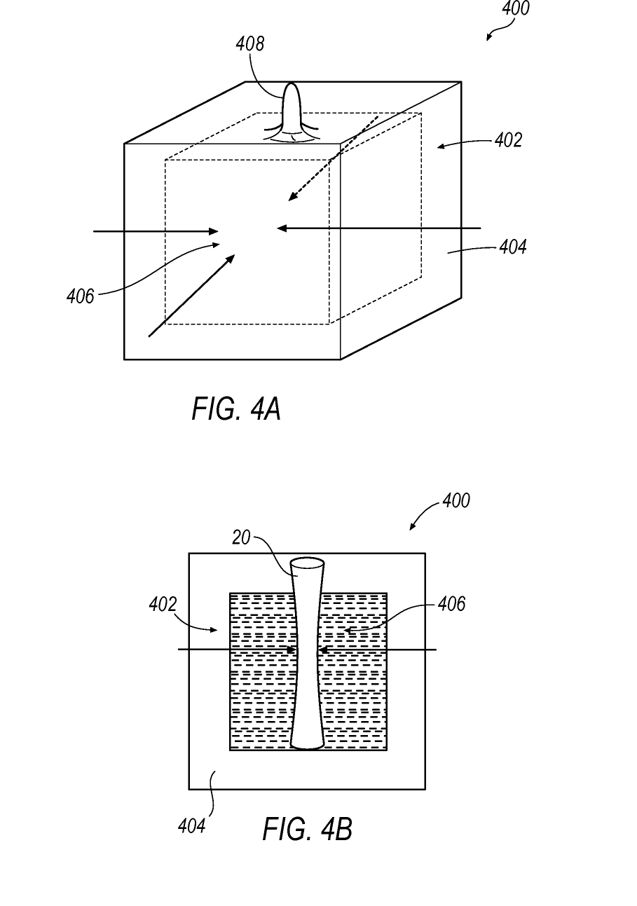

Referring to FIGS. 4A and 4B, during the freezing process of a quantity of liquid in a frozen cell cube 400 (e.g., FIG. 4A), the liquid may initially freeze at an outer area 402 within the frozen cell cube 400, forming a solid or ice “shell” 404 around a remaining quantity of unfrozen liquid 406. The ice shell 404 generally forms a closed volume, trapping a quantity of unfrozen liquid 406 inside and sealing it within the ice shell 404 (e.g., as shown in FIGS. 4A and 4B). As the initially unfrozen quantity of liquid 406 in the central or inner portion subsequently freezes (e.g., the ice shell 404 progresses inwards, as indicated by the arrows in FIG. 4A), the ice shell 404 is forced outward by the remaining liquid within the shell, as it freezes into a solid and thereby expands in volume. For example, some urea solutions may freeze at 11° C. and expand in volume by 7-12 percent. Thus, as the ice shell 404 advances inwardly, the unfrozen liquid 406 freezes creating inner pressure that pushes outwards, thereby forcing the ice shell 404 to expand in volume. The pressure may further force the unfrozen liquid to push upwards against the top of the ice shell 404 consequently causing the ice to spike or crown 408. With respect to a container defining a volume, this expansion from inside-out may damage the exterior walls, in some cases beyond repair.

Any device at the surface or outside of the unfrozen liquid 406 will not help reduce the aforementioned expansion as the liquid freezes into a solid. Accordingly, with reference to FIG. 4B, to accommodate the expansion of the initially unfrozen liquid 406 within the ice shell 404, a compliant element 20 (e.g., a compliant tubing or foam) may be maintained in the area inside the ice shell 404. Consequently, the liquid still contained within the ice shell 404 will create pressure within the ice shell 404 that compresses the compliant element 20, thereby reducing the total volume of the compliant element 20 inside the ice shell 404. The compression of the compliant element 20 may proportionately absorb the expansion of the initially unfrozen liquid 404 as it freezes into a solid.

Referring now to FIG. 2, the compliant element 20 may absorb a volumetric expansion of liquid tending to accumulate within the ice “shell” as it turns into a solid. For example, the compliant tubing or foam element 20 may initially be positioned about a perimeter of the filter element 18, in an outer annular area of the interior of the housing. The perimeter or outer annular area may be contained within a secondary freezing zone 24 that is itself contained within a primary freezing zone 26 associated with the formation of the ice shell, such that the ice shell forms with the compliant element 20 at least partially trapped inside. In one example, the compliant element 20 is fully trapped within the ice shell so that it is compressed by the expanding liquid/solid, thereby decreasing the total volume of the compliant element 20 (e.g., compliant element 20 is contained substantially in the secondary freezing zone 24). That is, in some instances the entire filter element 18 is surrounded by an ice shell, even the top area of the secondary and primary freezing zones 24, 26 relative to the inlet 14. The compliant tubing or foam element 20 may compress as pressure resulting from the expanding liquid/solid inside the ice shell increases, thereby decreasing the total volume of the compliant tubing or foam element 20. Additionally, fluid communication between a compliant element 20 and the external atmosphere may also be permitted. More specifically, a tube (acting as the compliant tubing or foam element 20) may be positioned within the housing 12 with each end arranged outside the container 10 and/or housing 12, so that air is squeezed out of the tube, or the tube is otherwise compressed, by ice forming within the housing 12. The compression of the compliant element 20 may therefore allow for proportional expansion of ice or solid within the volume of the housing 12.

As illustrated in FIG. 2, the formation of the ice shell may occur outside the dashed-line border indicating the primary freezing zone 26, within the housing 12. The secondary freezing zone 24 of the housing 12 may generally tend to accumulate liquid, e.g., water or urea, within an ice shell that forms in the primary freezing zone 26 of the housing 12. The compliant element 20 may generally be included inside the primary freezing zone 26 (e.g., at least partially inside the primary freezing zone 26 and within of the secondary freezing zone 26). Accordingly, the ice shell may form outside of the compliant element 20. As the liquid within the ice shell (e.g., within the secondary freezing zone 24) subsequently freezes into a solid, the compliant element 20 may allow expansion of the liquid turning into a solid by compressing. By way of explanation, the secondary and primary freezing zones 24, 26 may be positioned such that a quantity of liquid disposed in the housing 12 will freeze in a first stage, wherein a first quantity of the liquid contained within the primary freezing zone 26 of the container 10 will freeze, and a second stage, wherein at second quantity of liquid within the secondary freezing zone 24 will freeze, wherein the first stage precedes the second stage.

The compliant element 20 may thus generally limit a quantity of liquid that may be present at a given time within the housing 12, and in particular within the secondary freezing zone 24, to allow expansion of the liquid as it turns into a solid. By limiting a quantity or volume of liquid contained within the ice shell, outward expansion of the ice shell (and a resulting force imparted to the housing 12 by such expansion) is limited or eliminated entirely. Significantly, in contrast to previous approaches, the exemplary illustrations may result in no additional stress to the housing 12 due to formation of the solid as a result of freezing, since the amount of liquid and ice are limited to an amount where an internal volumetric capacity of the housing 12 is not exceeded by the expanding solid, e.g., frozen urea or water. Accordingly, when the temperature drops to the freezing point of a given liquid, the container will not be damaged by the resulting expansion of liquid as it transitions to a solid.

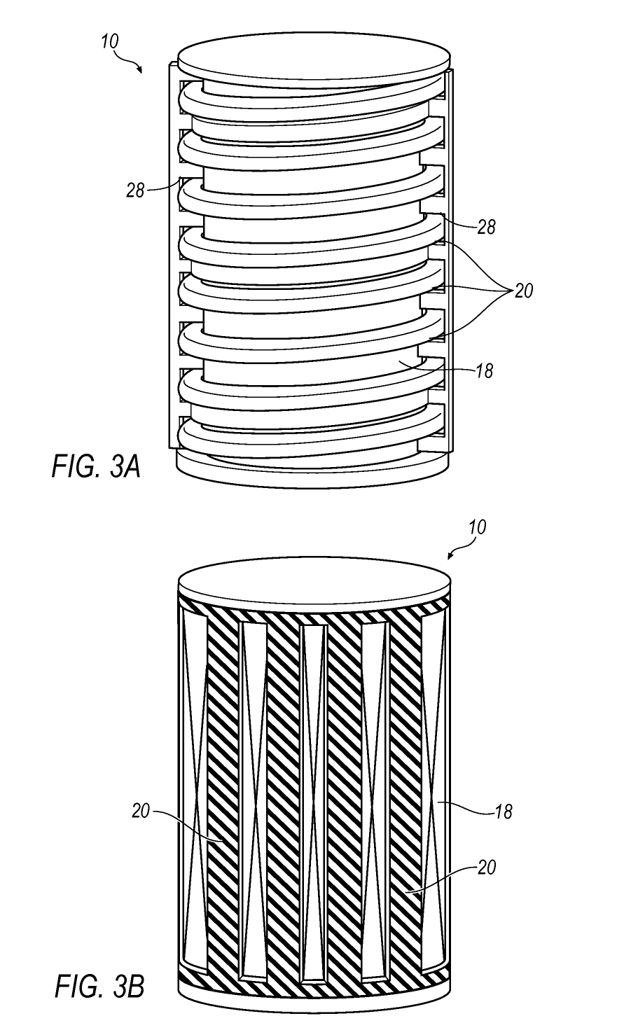

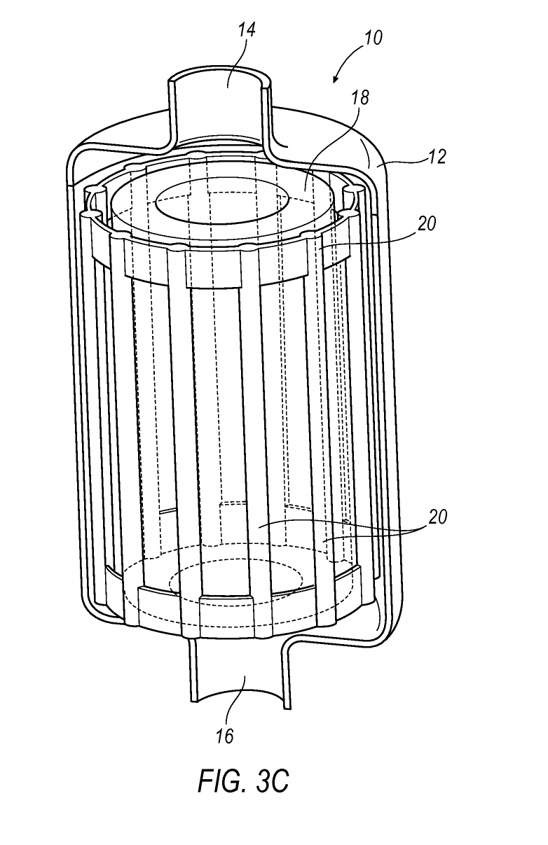

Referring now to FIGS. 3A-3C, any variety of compliant elements 20 may be employed, including but not limited to a compliant tubing or foam. In one exemplary illustration, a compliant element 20 may include a compressible closed-cell foam material that is generally positioned around a filter element 18 within a housing 12. Exemplary closed-cell foam materials may be formed in a stamping or trimming process. The foam material may then be compressed when a solid shell forms within the housing 12, and remaining liquid contained within the shell freezes into solid, preventing or at least reducing outward expansion by the shell. As such, the compressible foam may define an initial thickness or volume within the housing 12 and primary freezing zone 26, and this initial volume may be compressed or reduced as the liquid expands into a solid within the shell. A compliant closed-cell foam element 20, which does not absorb liquids such as water, may displace liquid disposed in the secondary freezing zone 24, limiting the amount of liquid that can be trapped within the ice shell. The compliant element 20 may “absorb” an increase in volume of the liquid within the ice shell as it freezes into a solid, by compressing in response to liquid that is freezing and expanding into a solid within the initially-formed ice shell.

In another example, the absorbing or compliant element 20 may include a relatively flexible (in comparison to ice and/or the housing 12) tubing, e.g., as illustrated in FIG. 3A and 3C. The compliant tubing element 20 may define an initial volume within the housing 12, which limits an amount of liquid contained within the ice shell. The compliant tubing element 20 may be compressed into a smaller volume within the housing 12 (e.g., a compressed volume) after the ice shell forms and the liquid contained within the shell continues to freeze, expanding into a solid. The compliant tubing element 20 may thus resist damage to the housing 12 by limiting an amount of liquid within the housing 12, and significantly, within the primary freezing zone 26 where liquid contained within the housing 12 is likely to form a shell. Accordingly, the compliant tubing element 20 may thereby reduce or eliminate entirely stress on the housing 12 that might otherwise result from the expansion of the liquid into a solid.

A compliant tubing element 20 may be formed of a plastic, rubber, or other water- resistant or chemical-resistant material, merely as examples. An exemplary tubing can have any configuration that is convenient, such as a single strip extending along an outer side of the filter element 18, or the tubing may be positioned about a perimeter or outer diameter 22 of the filter element 18, merely as examples.

The compliant element 20 may surround the filter element 18 helically or as a coil (e.g., as illustrated in FIG. 3A), may encompass the perimeter of the filer element 18 vertically (e.g., as illustrated in FIG. 3B and 3C), for example. The compliant element 20 may include an annular configuration whereby it may be rolled into a ring shape for installation into filter space between the housing 12 and the outer diameter 22 of the filter element 18. As illustrated in FIG. 3C, the compliant element may generally define a spacing from the filter element 18 so as to not disrupt the flow of liquid through the filter element 18 and to allow enough buffer room to absorb the expansion of liquid as it freezes.

Referring to FIG. 3A, the container 10 may include a support member 28, such as a guide, rack, frame, or clip(s), may be employed to support a compliant element 20 to ensure the compliant element 20 remains positioned as desired within the housing 12. For example, a “plastic rack” 28 (e.g., as shown in FIG. 3A) may generally maintain a desired spacing of the compliant element 20 as it encompasses the filter element 18. Additionally, the plastic rack 28 may maintain the compliant element 20 with a desired spacing or positioning within the container 10. For example, with reference to FIG. 2, the compliant tubing or foam element 20 may be maintained in a proper position between an inner diameter 30 of the compliant element 20 and the filter element 18, thereby ensuring the compliant element 20 does not block liquid passing through the filter element 18 and maintaining a consistent filtration area along a length of the filter element 18, as will be described further below. Moreover, the compliant element 20 may be maintained with a desired spacing or gap between an outer diameter 32 of the compliant element 20 and an inner surface 34 of the housing 12 to ensure that at least a portion, and in some cases an entire portion, of the compliant element 20 is positioned within/inside a primary freezing zone 26 of the housing 12. The primary freezing zone 26 may include at least in part the space between the inner surface 34 of the housing 12 and the outer diameter 32 of the compliant element 20. The secondary freezing zone 24 may include at least in part the space between the outer diameter 32 of the compliant element 20 and the outer diameter 22 of the filter element.

Referring back to FIG. 3A, the support member 28, such as a clip, guide, or other fastener, may be employed to position the compliant element 20 around a perimeter of the filter element 18. For example, a clip may generally hold a portion of flexible tubing, e.g., a tube ring, around an outer perimeter so that the tubing is properly positioned to limit liquid accumulation within the ice shell, thereby reducing an amount of ice that can form within the ice shell, and reducing potential damage to the housing 12 and/or filter element 18. The compliant element 20 may likewise be secured around the filter element 18 via a filter top cap or bottom plate, as in the case of a vertically configured complaint element 20, to ensure proper spacing and/or positioning of the compliant element 20 within the housing 12. The compliant element 20 may be held or welded to the top cap and/or bottom plate so that the compliant element 20 maintains proper spacing and position.

Alternatively or in addition to securing the compliant element 20 by mechanical fastening, the compliant element 20 may be formed to fit around a filter element 18 with a desired spacing. For example, a portion of tubing may be sized for a given filter element 18, such that when two ends of the tube are held or welded to one another, a tube or compliant ring is formed that fits about the outer perimeter 22 of the filter element 18. Moreover, in such examples, gas (e.g., air) may be sealed inside the tubing, thereby decreasing compliance of the tubing, e.g., to increase overall capacity for absorption of volumetric expansion. Referring to FIG. 3B, a compliant foam element 20 may be sized form fittingly around a filter element 18 with desired spacing/positioning within the container 10 as previously mentioned. As such, the two ends of the of the complaint foam element 20 may be fastened/held together allowing the compliant element 20 to be placed around the filter element 18. Additionally, with reference to FIG. 3C, a compliant tubing element 20 may be configured as a cage and sized to fit around the filter element 18 with a desired spacing. For instance, the tubing may be aligned vertically and coupled together via ring shaped connector. Air may be trapped or sealed inside the tubes thereby increasing the overall capacity for absorption of the compliant tubing element 20. The diameter of the compliant element 20 may be larger than the diameter of the filter element 18 such that there is a spacing or gap between the filter element 18 and compliant element 20. Accordingly, the compliant element 20 may be easily removed for replacement and/or cleaning of the filter element 18.

Referring now to FIG. 2, the compliant element 20 may be sized to define a gap or spacing between an inside diameter 30 of the compliant element 20 and a filter element 18. For example, an inside diameter 30 of a compliant element 20 may generally be larger than an outside diameter 22 of the filter element 18. For instance, a closed-cell foam compliant element 20 may be larger than the outside diameter 22 of filter element 18. Accordingly, the compliant element 20 does not prevent or obstruct flow of liquid that flows through the filter element 18, e.g., a liquid flow being filtered by the filter element 18. Additionally, the spacing provides a buffer zone to absorb the ice/solid expansion as liquid freezes so as to not damage the filter element 18.

As generally described above, the compliant element 20 may also be smaller than an interior surface 34 of the filter housing 12. For example, an outside diameter 32 of the compliant tubing or foam element 20 may be smaller than an inside diameter 34 of a filter housing 12 into which the filter element 18 and compliant element 20 are installed. A gap or spacing between the compliant element 20 and an interior surface 34 of the filter housing 12 may generally allow an ice shell to form initially outside of the compliant element 20 (e.g., ice formation in the primary freezing zone 26). Accordingly, when the ice shell forms outside of the compliant element 20, the liquid still contained within the ice shell will create pressure within the ice shell that compresses the compliant element 20—e.g., a tube or foam—thereby reducing the total volume of the compliant element 20 inside of ice shell. The compliant element 20 may define an initial volume within the housing 12, and a subsequent compressed volume smaller than the initial volume upon formation of the ice shell. In some exemplary approaches, a total volume change of a liquid contained in the container 10 may be between about 7-15 percent, and this may be fully absorbed by the compliant element 20 in the container 10. A difference between the initial and compressed volumes of the compliant element 20 may correspond to a difference in volume between a volume formed initially within an ice shell and a volume of ice formed by liquid remaining initially within the ice shell.

As noted above, the compliant element 20 may be configured to absorb a change in volume associated with a liquid, e.g., urea or water, contained within an initial ice shell that forms within a filter housing 12, which subsequently expands as it freezes into a solid, such as ice. To prevent damage to a housing 12, the compliant element 20 may have a compliance and initial volume sufficient to absorb the expansion of the liquid freezing into a solid. According to one example, the volume of the compliant element 20 may be greater than 15 percent of the volume of the filter housing 12 to allow for total absorption as the liquid expands during the freezing process. Factors to consider in designing a compliant element 20 sufficient to prevent damage to a housing 12 may include the initial size of an ice shell within a given housing 12, a volume contained within the ice shell where a liquid may accumulate, and the volumetric expansion coefficient of a liquid contained within the container 10.

The exemplary illustrations are not limited to the previously described examples. Accordingly, it is to be understood that the above description is intended to be illustrative and not restrictive. Many embodiments and applications other than the examples provided would be possible upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

1. A container, comprising:
a housing;
a filter element configured to separate a contaminant from a liquid; and
a compliant element surrounding a perimeter of the filter element within the housing.

2. The container of claim 1, wherein the compliant element is positioned at least partially inside a primary freezing zone of the housing such that the compliant element is contained substantially within a secondary freezing zone of the housing.

3. The container of claim 2, wherein the primary and secondary freezing zones are positioned such that a quantity of liquid disposed in the housing will freeze in a first stage, wherein a first quantity of the liquid contained within the primary freezing zone of the container will freeze, and a second stage, wherein a second quantity of liquid within the secondary freezing zone will freeze, wherein the first stage precedes the second stage.

4. The container of claim 2, wherein the compliant element defines an initial volume and is configured to be compressed within the housing to a compressed volume, wherein a difference between the initial volume and the compressed volume corresponds to a volumetric expansion of a quantity of liquid contained within the secondary freezing zone as the liquid freezes into a solid.

5. The container of claim 2, wherein the compliant element defines a gap between an outer surface of the compliant element and an interior surface of the housing.

6. The container of claim 2, wherein the compliant element defines a gap between an inner surface of the compliant element and an outer surface of the filter element.

7. The container of claim 1, wherein the compliant element is a liquid-resistant material.

8. The container of claim 7, wherein the water-resistant material is a closed-cell foam material.

9. The container of claim 2, wherein the compliant element is a tube extending about the perimeter of the container.

10. The container of claim 1, further comprising a guide disposed along at least one side of the filter element, the guide positioning the compliant element about the perimeter of the filter element.

11. A filter device, comprising:
a housing having an inlet and an outlet, the housing defining a volume;
a filter element arranged in the housing configured to separate contaminant from a liquid;
a compliant element arranged axially around an outer perimeter of the filter element, wherein the compliant element is configured to absorb the expansion of a liquid as it transitions to a solid; and
wherein the compliant element is compressible in proportion to the expansion of the liquid as it transitions to the solid.

12. The device of claim 11, wherein the compliant element is positioned at least partially inside a primary freezing zone of the housing such that the compliant element is contained substantially within a secondary freezing zone of the housing.

13. The device of claim 12, wherein the primary and secondary freezing zones are positioned such that a quantity of liquid disposed in the housing will freeze in a first stage, wherein a first quantity of the liquid contained within the primary freezing zone of the container will freeze, and a second stage, wherein a second quantity of liquid within the secondary freezing zone will freeze, wherein the first stage precedes the second stage.

14. The device of claim 12, wherein the compliant element defines an initial volume and is configured to be compressed within the housing to a compressed volume, wherein a difference between the initial volume and the compressed volume corresponds to a volumetric expansion of a quantity of liquid contained within the secondary freezing zone as the liquid freezes to solid.

15. The device of claim 11, wherein the compliant element defines a gap between an outer surface of the compliant element and an interior surface of the housing.

16. The device of claim 11, wherein the compliant element defines a gap between an inner surface of the compliant element and the outer perimeter of the filter element.

17. The device of claim 11, further comprising a guide disposed along at least one side of the filter element, the guide positioning the compliant element about the perimeter of the filter element.

18. The device of claim 11, wherein the complaint element surrounds the perimeter of the filter element in one of a helical coil and vertical arrangement.

19. A container, comprising:
a housing having an inlet and an outlet;
a filter element configured to separate a contaminant from a liquid;
a compliant element arranged on an axial outer diameter of the filter element; and
wherein the housing defines a primary freezing zone and a secondary freezing zone, wherein the compliant element is positioned at least partially inside the primary freezing zone such that the compliant element is contained substantially within the secondary freezing zone.

20. The container of claim 19, wherein the compliant element defines an initial volume and is configured to be compressed within the housing to a compressed volume, wherein a difference between the initial volume and the compressed volume corresponds to a volumetric expansion of a quantity of liquid contained within the secondary freezing zone as the liquid freezes into a solid.
